(19) United States
(12) Patent Application Publication
(10) Pub. No.: US 2010/0003114 A1
(43) Pub. Date: Jan. 7, 2010

(54) Lug tender

(76) Inventor: John Mather, South Haven, MI (US)

Correspondence Address: FLYNN THIEL BOUTELL & TANIS, P.C., 2026 RAMBLING ROAD, KALAMAZOO, MI, 49008-1631, US

(21) Appl. No.: 12/217,592

(22) Filed: Jul. 7, 2008

(51) Int. Cl. B65G 65/23

(52) U.S. Cl. 414/404; 414/418; 414/810

(57) ABSTRACT

A lug tender includes a conveyor belt-type feed bed having flexible conveyor belts for transporting lugs from a first, feed end, between side guard rails to a hopper or dumping end. At the hopper end, the side rails are omitted so that a grasping mechanism can address the side walls of the lug, grasping same and rotating the lug, inverting the lug over a feed hopper. Fruit carried by the lug is thus deposited in the feed hopper. A guard placed over the feed hopper prevents the lug from entering the feed hopper. A pusher bar displaces the lug across the guard to free up the hopper for the subsequent lug. The emptied lug can then be removed either manually or mechanically for recycling.

### FIELD OF THE INVENTION

The invention relates to container handling equipment, and specifically to equipment for inverting open top containers to deliver the contents thereof.

### BACKGROUND OF THE INVENTION

In produce handling operations, it is common for open-top containers, commonly known as lugs, to be used in the field for initially receiving produce or fruit harvested in the field. Said lugs are generally of a size amenable to being handled by an individual, and must be sufficiently shallow so as to prevent fruit from becoming damaged by the weight of access fruit being loaded on top of it. Fruit loaded into said lugs must then be transferred in a processing facility from the lugs into a handling or packaging machine or environment for manual processing. One such type of machine includes a hopper into which said lugs are emptied, the fruit, such as blueberries, being thence distributed over a conveyor belt for further processing and evaluation. Current practice is for the lugs to be individually lifted and overturned by an operator, the fruit being emptied into the hopper manually. Several problems arise from this method, however. First, the repetitive lifting and overturning of the lugs is difficult physical labor. Second, the inconsistent handling of the lugs can cause variation in the condition of the fruit as it is received by the hopper. Third, the rate at which the lugs are manually emptied into the hopper can vary, causing surges and lulls in the processing rate within the handling and packaging operation. Accordingly, it would be advantageous to provide a method of transferring produce from the lugs into the packaging and sorting process in a manner that is consistent both in the physical treatment of the produce and in the rate of transfer of the produce.

Other objects and purposes of the invention, and variations thereof, will be apparent upon reading the following specification and inspecting the accompanying drawings.

### SUMMARY OF THE INVENTION

A lug tender includes a conveyor belt, a hydraulic, pneumatic or electromechanical grasping mechanism including a pivoting arm mechanism and a pusher arm positioned over a fruit-receiving hopper.

### BRIEF DESCRIPTION OF THE DRAWINGS

FIG. 1 is a side view of a lug tender according to the invention.

FIG. 2 is an end view of the lug tender of FIG. 1.

FIG. 3 is an end view of the lug tender with grasping arms in the open position.

FIG. 4 is an end view of the lug tender of FIGS. 1-3 with the grasping arms in the closed position.

FIG. 5 is a plan view of the lug tender according to FIGS. 1-4 with a lug in the staging position.

FIG. 6 is a side view of the lug tender of FIGS. 1-5 showing a sequential dumping of the lug into the hopper.

FIG. 7 is a plan view of the lug tender of FIGS. 1-6 with a lug in the dumping position over the hopper.

FIG. 8 is a plan view of the lug tender with the pusher arm engaging the lug.

FIG. 9 is a plan view with the pusher arm pushing the lug across the hopper.

FIG. 10 is a plan view of the lug tender with the pusher arm and the lug substantially removed from the hopper.

### DETAILED DESCRIPTION OF THE INVENTION

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

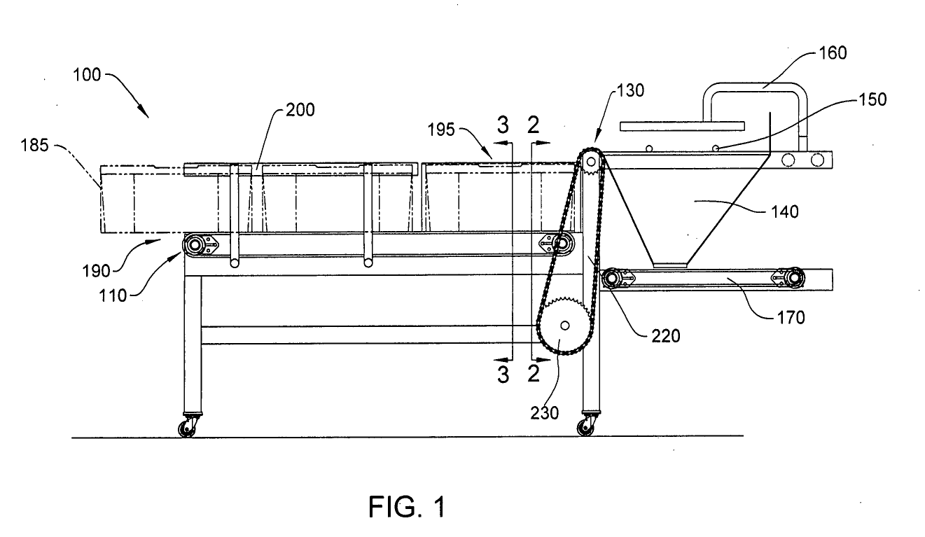

Referring to FIG. 1, a lug tender 100 includes a conveyor belt system 110, clamping head mechanism 120, a clamping head rotation mechanism 130, a hopper 140 having a guard 150 thereover and a pusher arm 160 arranged over the hopper 140. The hopper 140 is arranged over a product conveyor 170.

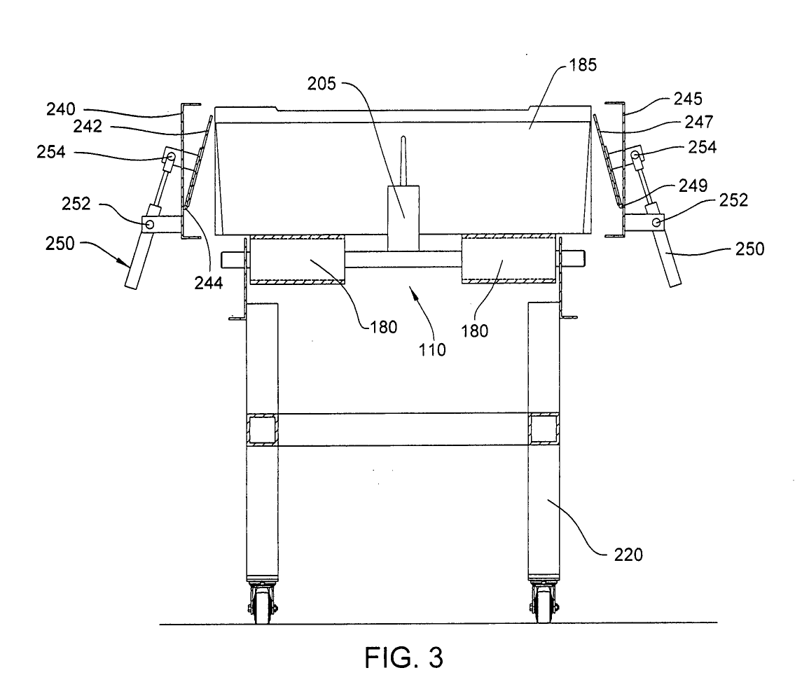

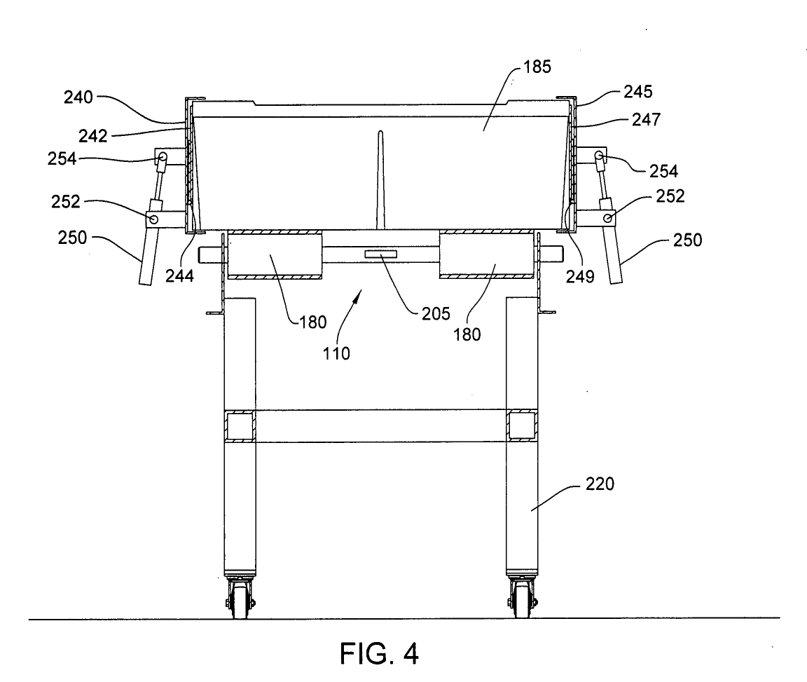

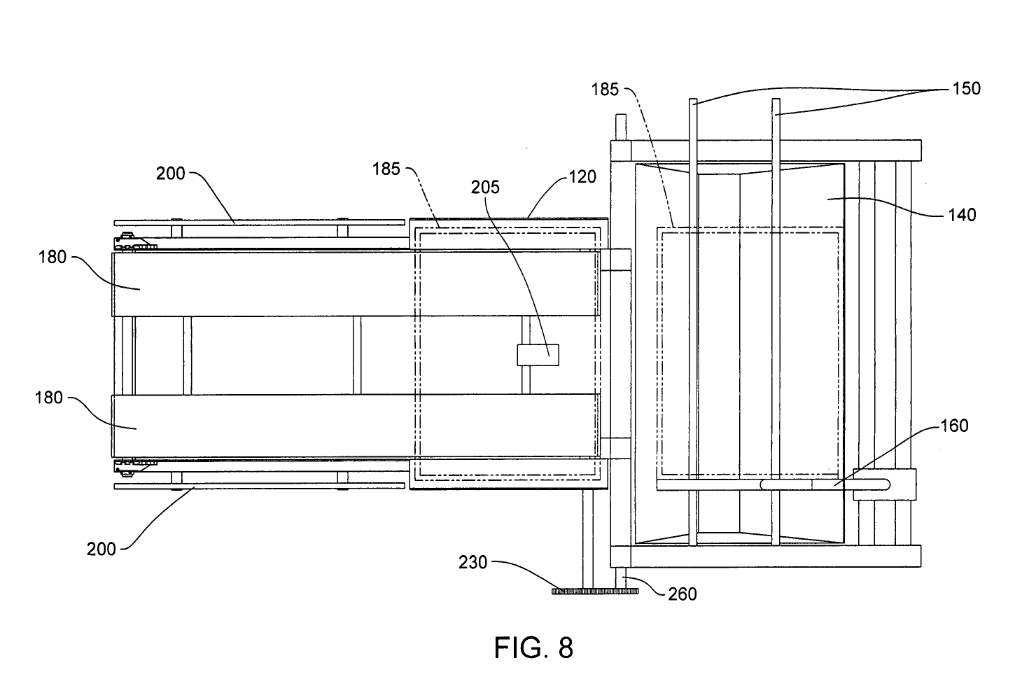

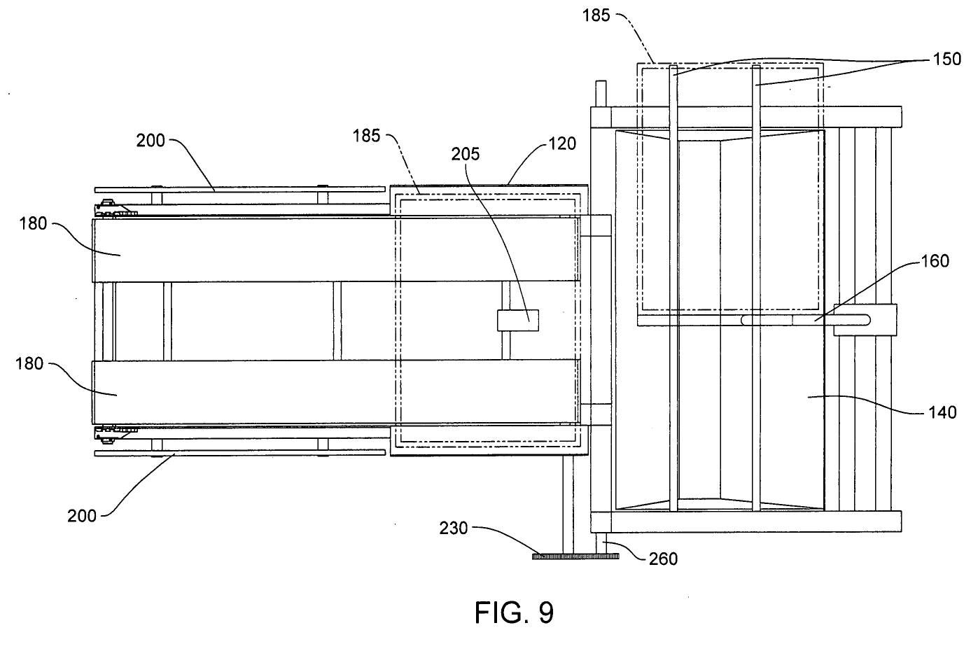

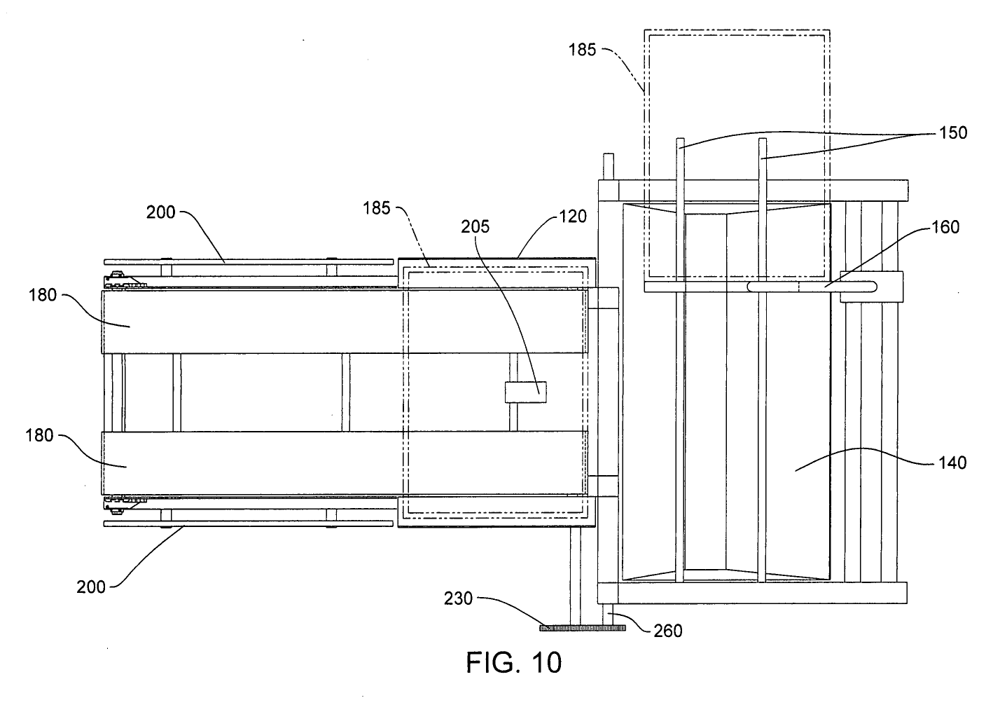

Referring to FIGS. 1-3, the conveyor belt system 110 includes a pair of conveyor belts 180 each in the form of a continuous driven loop. The belts 180 form a moving platform for carrying a plurality of lugs 185 from a feed end 190 of the conveyor 110 to a load end 195. The conveyor system 110 is bounded by a pair of side rails 200 for centering the lugs 185 on the conveyor system 110. The side rails 200 terminate before the load end 195 of the conveyor 110. The conveyor 110 further includes a conveyor stop 205 positioned within the load end 195. The conveyor stop 205 is rotatably mounted and movable between a lowered position (FIGS. 4 and 7-10) between the conveyor belt 180 and a raised position (FIG. 3) extending above the surface of the conveyor belt 180.

The clamping head mechanism 120 is positioned at the load end 195 of the conveyor 110. The clamping head mechanism 120 is pivotably mounted to the support structure 220 of the lug tender 100 by the clamping head rotation mechanism 130. The clamping head rotation mechanism 130 is rotationally driven by a chain and sprocket assembly 230. Referring to FIGS. 3-5, the clamping head mechanism 120 includes a pair of clamping heads 240, 245. Each of the clamping heads includes an inner plate 242, 247 pivotally mounted thereto by pins or hinges 244, 249. Each clamping head 240, 245 and inner plate 242, 247 is also pivotally mounted to a respective actuator 250 by respective pivot pins 252, 254. Each actuator 250 can be in the form of an electric linear actuator or an equivalent pneumatic or hydraulic piston arrangement. The clamping heads 240, 245 are further slidably mounted on a clamping head backbone 270 that is fixed for rotation with a clamping head drive shaft 260. Referring to FIGS. 3 and 4, as each actuator 250 retracts, the respective clamping head 240, 245 is drawn inwardly toward the conveyor 110 so as to grasp a lug 185 positioned in the load end 195 of a conveyor 110.

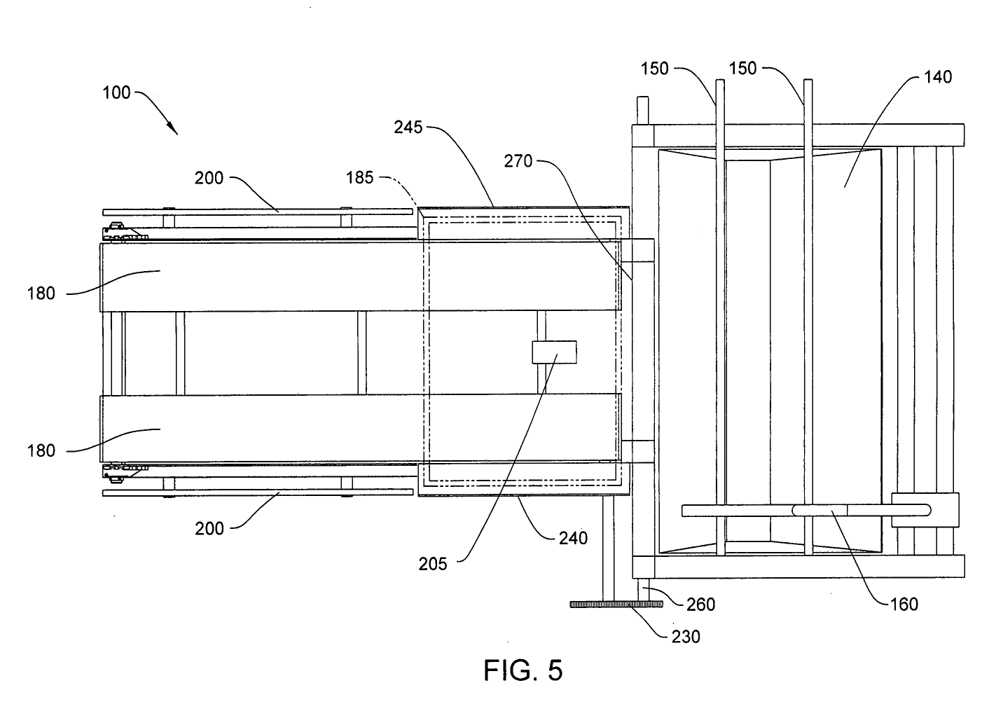

Referring to FIGS. 1 and 5, the hopper 140 has a rectangular upper opening tapering down in a funnel-like manner to the product conveyor 170. A pair of hopper guards 150 are positioned over the hopper 140 in a direction transverse to the conveyor 110. A pusher arm 160 is movably mounted to the hopper 140 for sliding motion transverse to a longitudinal axis of the conveyor 110. An actuation mechanism (not shown) moves the pusher arm 160 across the face of the opening of the hopper 140.

In operation, lugs 185 are loaded onto the feed end 190 of the conveyor 110. Each lug 185 is transported by the conveyor 110 between the side rails 200 toward the load end 195.

The conveyor stop block 205, when rotated into the upper position as shown in FIG. 3, prevents the lug 185 from fully occupying the load end 195 of the conveyor 110. The conveyor stop block 205 is then lowered so that the lug 185 can fully enter the load end 195 of the conveyor 110.

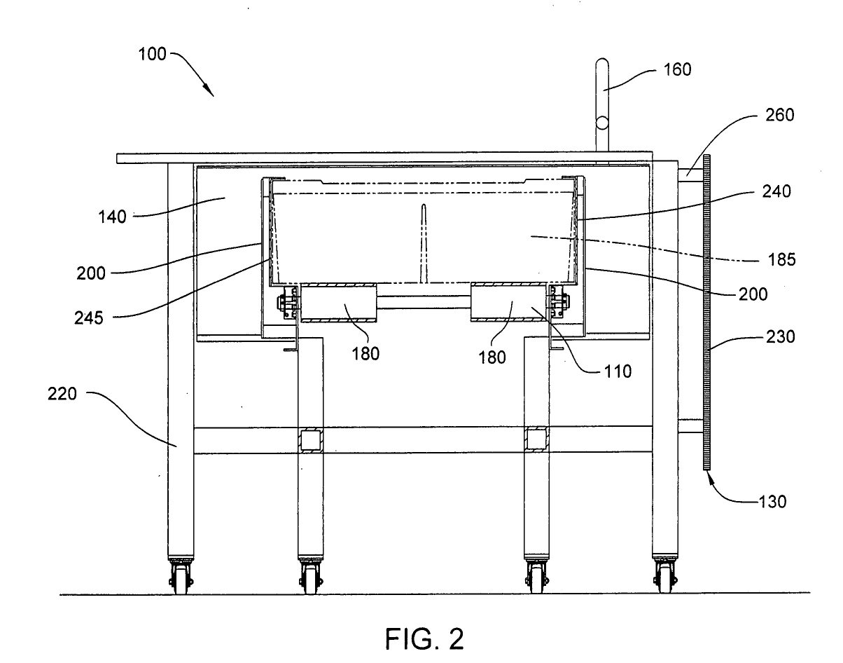

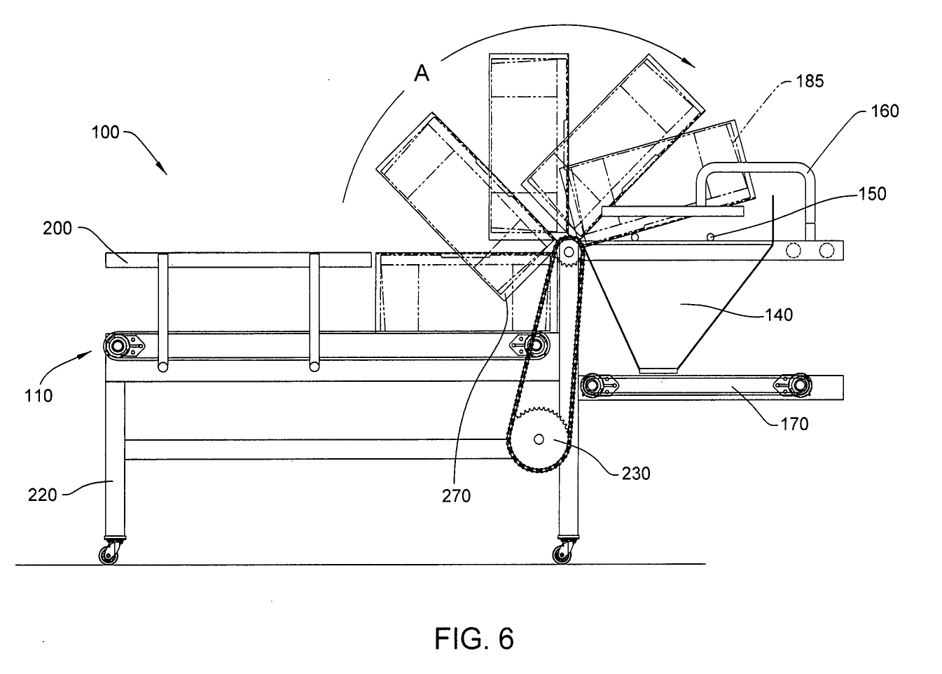

After the lug 185 is in position, the clamping head mechanism 120 can grasp the lug 185. Each of the actuators 250 is retracted so that the respective clamping heads 240, 245 are drawn inwardly to grasp the lug 185. Once the lug has been secured between the clamping heads 240, 245, the clamping head mechanism 120 is rotated by the clamping head rotation mechanism 130 about the clamping head drive shaft 260 (see FIGS. 2 and 6).

As the lug 185 is rotated about the clamping head drive shaft 260, as shown by the arrow A in FIG. 6, the product in question, such as blueberries, are emptied into the hopper 140 along the sloping walls thereof. As the lug 185 is fully inverted, the clamping head mechanism 120 releases the lug 185 onto the hopper guards 150.

As the clamping head mechanism 120 raises the lug 185, the conveyor stop block 205 rotates to the upward position to temporarily hold back a subsequent lug 185 to prevent it from hitting the underside of the lug 185 being raised by the clamping head mechanism 120. As the clamping head mechanism deposits the first lug 185 on the hopper guard 150, the conveyor stop block 205 lowers to allow the subsequent lug 185 to come into position for grasping by the clamping head mechanism 120.

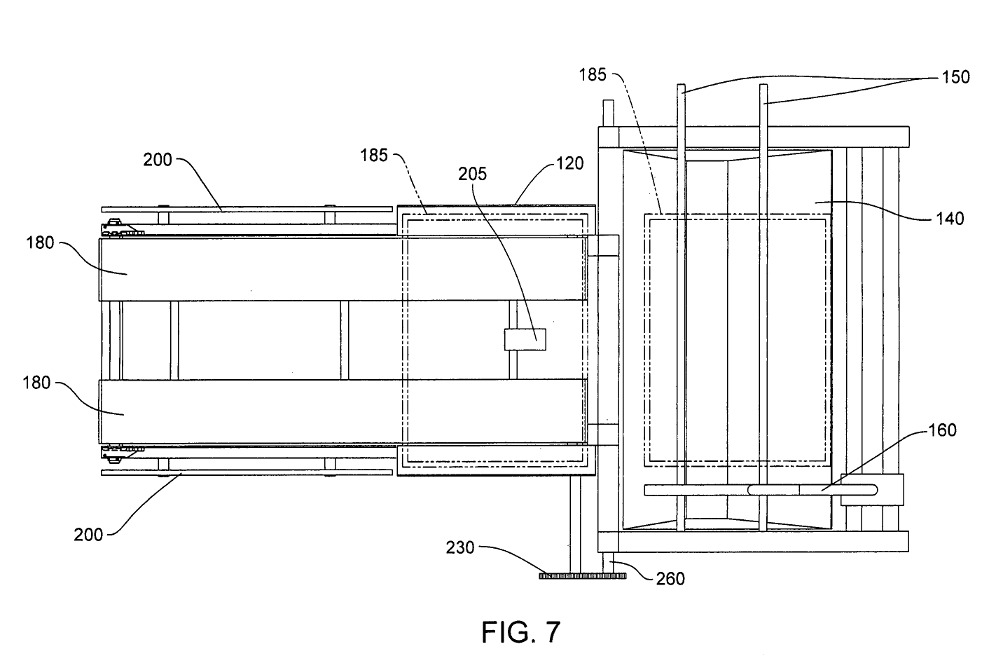

After the clamping head mechanism has rotated away from the lug 185 resting on the hopper guards 150, the pusher arm 160 is activated to move the lug 185 across the hopper guards 150 and off of the hopper 140 to prepare it for receiving the subsequent lug 185 (see FIGS. 7-10). The lug 185, upon being pushed by the pusher arm 160 off of the hopper guards 150, can then be removed either manually or by a subsequent mechanical conveyor system for reuse. After the pusher arm 160 evacuates the lug 185, the pusher arm 160 returns to the position shown in FIG. 7 in preparation for the subsequent lug 185 to be deposited by the clamping head mechanism 120 and the cycle repeats. The produce that has been deposited in the hopper 140 is conveyed from the lower end of the hopper 140 by the product conveyor 170 in a controlled manner.

Although particular preferred embodiments of the information have been disclosed in detail for illustration purposes, it will be recognized that variations or modifications of the disclosed apparatus, including the rearrangement of parts, lie within the scope of the present invention.

What is claimed:

1. A lug tender includes a conveyor belt-type feed bed having flexible conveyor belts for transporting lugs from a first, feed end to a second, hopper end, whereby lugs are transported from the first end to the second end, a grasping mechanism configured for addressing side walls of the lug, grasping and rotating the lug, and inverting the lug over a hopper, and a lug removal mechanism in the form of a hopper guard suspending the lug over the hopper and a pusher arm slidably mounted over the hopper to push the lug from over the hopper.

2. A lug tender, comprising:
a conveyor system connected to a support structure;
a clamping head mechanism connected to the support structure by a clamping head rotation mechanism;
a hopper connected to the support structure adjacent to the clamping head rotation mechanism; and
a pusher arm mechanism attached adjacent the hopper.

3. The lug tender according to claim 2, the conveyor belt further comprising a conveyor stop.

4. The lug tender according to claim 2, the clamping head mechanism comprising a backbone connected to the clamping head rotation mechanism and a pair of clamping heads movably mounted to the backbone, each clamping head including an actuator for moving the respective clamping head inwardly to a grasping position to grasp a lug positioned in a load end of the conveyor belt system.

5. The lug tender according to claim 4, the actuator comprising an electric linear actuator

6. The lug tender according to claim 4, the actuator comprising a pneumatic piston mechanism

7. The lug tender according to claim 4, the actuator comprising a hydraulic piston mechanism.

8. The lug tender according to claim 4, each clamping head comprising a first, inner portion and a second, outer portion, the inner portion being pivotally joined to the outer portion and to the actuator, and the outer portion being pivotally joined to the actuator and slidably connected to the backbone.

9. The lug tender according to claim 8, wherein the inner portion of each clamping head is parallel to the outer portion with the clamping head in the grasping position.

10. The lug tender according to claim 8, wherein the inner portion of each clamping head is pivotally connected to the backbone.

11. The lug tender according to claim 2, wherein the hopper comprises a hopper guard arranged transversely to a longitudinal axis of the conveyor system.

12. The lug tender according to claim 11, wherein the hopper guard comprises a pair of elongate members.

13. The lug tender according to claim 2, wherein the pusher arm mechanism comprises a pusher arm movably mounted relative to the hopper.

14. The lug tender according to claim 13, wherein the pusher arm is mounted for movement transversely relative to a longitudinal axis of the conveyor system.

15. A method for transferring a product from a receptacle to a product-handling apparatus using a receptacle handling apparatus including a conveyor, a grasping mechanism, and a hopper, comprising the steps of:
loading the receptacle onto the conveyor;
conveying the receptacle to the grasping mechanism;
grasping the receptacle on the conveyor;
inverting the receptacle to deposit the product within the hopper;
releasing the receptacle over the hopper; and
displacing the receptacle relative to the hopper.

16. The method according to claim 15, wherein the inverting step is performed by the grasping mechanism by rotation about a single axis between the conveyor and the hopper.
